(19) United States
(12) Patent Application Publication
(10) Pub. No.: US 2003/0106575 A1
(43) Pub. Date: Jun. 12, 2003

(54) Wafer guide and cleaning apparatus having the same

(76) Inventors: Bong-Ho Moon, Suwon (KR); Yong-Sun Ko, Suwon (KR); Won-Jun Lee, Seoul (KR); Yong-Myung Jun, Suwon (KR); In-Seak Hwang, Suwon (KR)

Correspondence Address: LEE & STERBA, P.C., Suite 2000, 1101 Wilson Boulevard, Arlington, VA, 22209, US

(21) Appl. No.: 10/294,684

(22) Filed: Nov. 15, 2002

(30) Foreign Application Priority Data
Dec. 12, 2001 (KR) 2001-78657

(51) Int. Cl. B08B 3/00

(52) U.S. Cl. 134/201; 134/84; 134/25.4

(57) ABSTRACT

A wafer guide for supporting at least one semiconductor wafer during a cleaning process, includes side panels having a plurality of side fixing grooves on an upper surface thereof for stabilizing the at least one semiconductor wafer and for maintaining a sufficient distance between a surface of the at least one semiconductor wafer and an adjacent surface; a center panel having a plurality of center fixing grooves on the upper surface thereof for supporting the at least one semiconductor wafer, each of the plurality of center fixing grooves having inner walls, wherein a contact line is formed on each of the inner walls of the center fixing grooves, and wherein the center panel is positioned between the pair of side panels; and a pair of fixing plates, one of the pair of fixing plates being fixedly attached at each end of the center panel and the pair of side panels.

### BACKGROUND OF THE INVENTION

1. Field of the Invention

The present invention relates to a wafer guide and a cleaning apparatus having the same that is capable of reducing a contact area between the wafer guide and a semiconductor wafer, thereby preventing residue from remaining on the semiconductor wafer after a cleaning process.

2. Description of the Related Art

In general, to fabricate a semiconductor device, a plurality of layers such as an oxide layer, a nitride layer and a metal layer are formed on a semiconductor wafer and patterned by means of an etching process. After the etching process is completed, a cleaning process is performed. During the cleaning process, the semiconductor wafer is dipped into a bath filled with a cleaning solution to remove unnecessary films, such as a photoresist film or an etching mask film. During the cleaning process, a plurality of wafers may be mounted on the wafer guide and simultaneously cleaned. The wafer guide prevents the plurality of wafers from falling over and positions the wafers at sufficient intervals during the cleaning process.

Thus far, various attempts have been made to produce a wafer guide capable of preventing residue from remaining on a wafer, in particular at a contact portion of the wafer, i.e., the portion of the wafer with which the wafer guide is in contact.

FIG. 1 illustrates a conventional wafer guide according to the prior art. The wafer guide 2 includes a pair of side panels 10a and 10b, a center panel 12, which is located between the side panels 10a and 10b, and a pair of fixing plates 14a and 14b. Each one of the fixing plates 14a, 14b is located at an end of the side panels 10a, 10b and the center panel 12 and is fixedly connected thereto. Each of the side panels 10a and 10b has a plurality of V-shaped side fixing grooves 11a and 11b, respectively, on an upper surface thereof to position a wafer on the wafer guide. The center panel 12 has a plurality of Y-shaped center fixing grooves 13 on an upper surface thereof. Inner walls of the center fixing grooves 13 form a contact plane to contact a wafer 18. Each of the fixing plates 14a and 14b has a protrusion 16a and 16b, respectively, outwardly extending from a top end thereof.

The side fixing grooves 11a and 11b of the side panels 10a and 10b do not contact a thin film formed on a surface of the wafer 18 and serve only to stabilize the wafer 18, whereas the center fixing grooves 13 contact a thin film on the surface of the wafer 18 and primarily support the wafer 18. Prior to the cleaning process a plurality of wafers 18 having a thin film 19 on the surface thereof are inserted into the wafer guide 2. The plurality of wafers 18 are inserted into the side fixing grooves 11a and 11b and the center fixing grooves 13. During the cleaning process, the wafer guide 2 is placed in a bath and the bath is filled with a cleaning solution. The purpose of the cleaning solution is to remove the thin film 19 on the wafers 18. The thin films 19 are removed by a chemical reaction between the cleaning solution and the thin films 19. Finally, after the cleaning process is complete, the wafer guide 2 is removed from the bath.

FIGS. 2A and 2B illustrate cross-sectional views taken along sectional lines IIa-IIa and IIb-IIb, respectively, of FIG. 1. As shown in FIG. 2A, in view of the manner in which the wafer 18 is stabilized by the side fixing grooves 11a, 11b, no residue from the thin film remain on that portion of the wafer. Specifically, the surface of the wafer 18 having the thin film 19 thereon and the side fixing grooves 11a, 11b are not in contact so the cleaning solution may remove the thin film 19. As illustrated in FIG. 2B, a portion of the wafer 18 is in contact with the center fixing grooves 13 thereby allowing a residue of the thin film 19 to remain on that portion of the wafer. This residue is caused by the fact that the cleaning solution is not able to contact sufficiently that portion of the thin film.

The reason the residue remains on the wafer is detailed with reference to FIGS. 3A through 3C. FIGS. 3A through 3C illustrate top views of the wafer 18 having a thin film 19 formed thereon in contact with the center fixing grooves 13 of the wafer guide 2.

As shown in FIG. 3A, the wafer 18 is vertically inserted into the center fixing grooves 13 of the center panel 12. Next, the wafer 18 having the thin film 19 thereon is dipped into the bath filled with the cleaning solution.

Next, as shown in FIG. 3B, most of the thin film 19 is removed by chemically reacting with the cleaning solution. A portion of the thin film 19′, however, remains on the wafer 18 where the thin film 19 on the wafer 18 is in contact with an inner wall of the center fixing grooves 13 of the center panel 13 of the wafer guide 2.

Next, as shown in FIG. 3C, a further portion of the remaining thin film 19′ is removed at both sides thereof through isotropical etching by the cleaning solution. A residue of the thin film 19″, however, still remains at a center portion of the center fixing groove 13 because the cleaning solution is not able to permeate into that area of the thin film.

### SUMMARY OF THE INVENTION

It is therefore a feature of an embodiment of the present invention to provide a wafer guide and a cleaning apparatus having the same that is capable of preventing residue from remaining on a wafer after a cleaning process is completed.

According to an embodiment of the present invention, there is provided a wafer guide for supporting at least one semiconductor wafer during a cleaning process, including a pair of side panels, each side panel having two ends, an upper surface, and a plurality of side fixing grooves on the upper surface thereof for stabilizing the at least one semiconductor wafer and for maintaining a sufficient distance between a surface of the at least one semiconductor wafer and an adjacent surface; a center panel having two ends, an upper surface, and a plurality of center fixing grooves on the upper surface thereof for supporting the at least one semiconductor wafer, each of the plurality of center fixing grooves having inner walls, wherein a contact line is formed on each of the inner walls of the center fixing grooves, and wherein the center panel is positioned between the pair of side panels; and a pair of fixing plates, one of the pair of fixing plates being fixedly attached at each end of the center panel and the pair of side panels. The contact line of the inner walls of each of the plurality of center fixing grooves may be formed by the inner walls having a rounded shape or a triangular prism shape. An upper surface of each of the plurality of center fixing grooves is sloped down toward the center thereof at an inclination of between about 20-45°. The side fixing grooves may be V-shaped.

According to another embodiment of the present invention, there is provided a wafer guide for supporting at least one semiconductor wafer during a cleaning process, including a plurality of panels, each panel having two ends, an upper surface, and a plurality of grooves on the upper surface thereof and being separated from each other, wherein each of the plurality of grooves has inner walls and the plurality of grooves of at least one of the plurality of the panels forms a contact line on the inner walls thereof to contact the at least one semiconductor wafer; and a pair of fixing plates attached to each of the panels at both ends thereof.

According to yet another embodiment of the present invention, there is provided a cleaning apparatus having a wafer guide for supporting at least one semiconductor wafer, the wafer guide including a pair of side panels, each side panel having two ends and a plurality of side fixing grooves at an upper surface thereof for stabilizing the at least one semiconductor wafer, the pair of side panels being separated from each other; a center panel having two ends and a plurality of center fixing grooves at an upper surface thereof for supporting the at least one semiconductor wafer, each of the plurality of center fixing grooves having inner walls, wherein a contact line is formed on each of the inner walls of the center fixing grooves by either rounding the inner walls or shaping the inner walls to descend toward the center from both side edges, and wherein the center panel is positioned between the pair of side panels; and a pair of fixing plates, one of the pair of fixing plates being fixedly attached at each end of the center panel and the pair of side panels.

### BRIEF DESCRIPTION OF THE DRAWINGS

The above and other features and advantages of the present invention will become more apparent upon review of a detailed description of preferred embodiments thereof with reference to the attached drawings in which:

FIG. 1 illustrates a perspective view of a conventional wafer guide in accordance with the prior art;

FIG. 2A illustrates a cross-sectional view taken along sectional line IIA-IIA of FIG. 1;

FIG. 2B illustrates a cross-sectional view taken along sectional line IIB-IIB of FIG. 1;

FIGS. 3A through 3C illustrate top views of a center fixing groove of a wafer guide having a wafer therein;

FIG. 4 illustrates a perspective view of a wafer guide in accordance with a first preferred embodiment of the present invention;

FIG. 5 illustrates a perspective view of a wafer guide in accordance with a second preferred embodiment of the present invention;

FIG. 6 illustrates a schematic view of a cleaning apparatus in accordance with the present invention;

FIGS. 7A through 7C illustrates views for explaining an operation of a wafer guide in accordance with the first preferred embodiment of the present invention; and

FIGS. 8A through 8C illustrates views for explaining an operation of a wafer guide in accordance with the second preferred embodiment of the present invention.

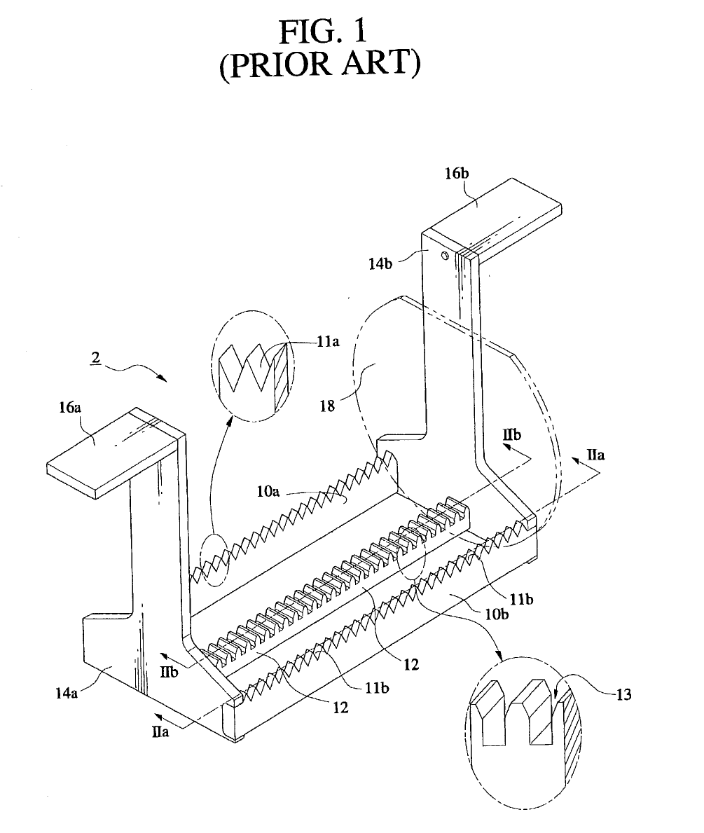

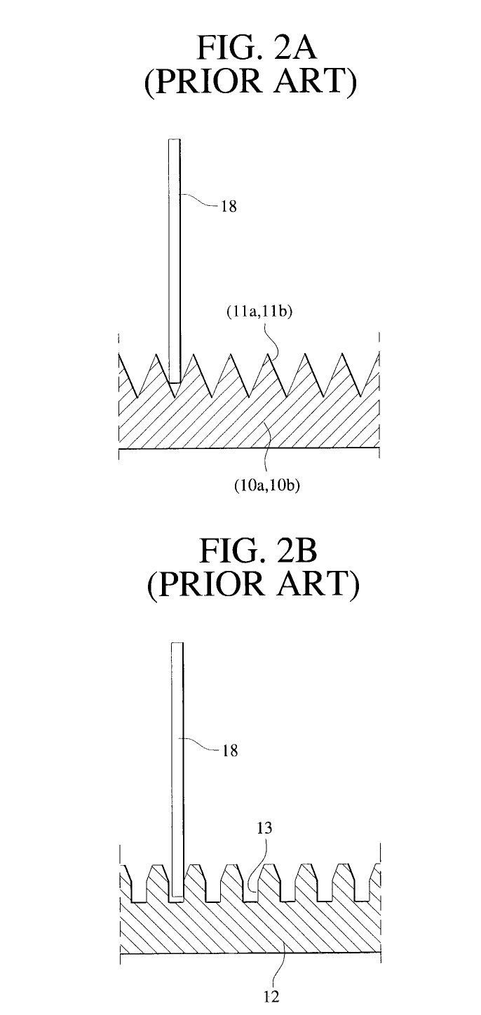

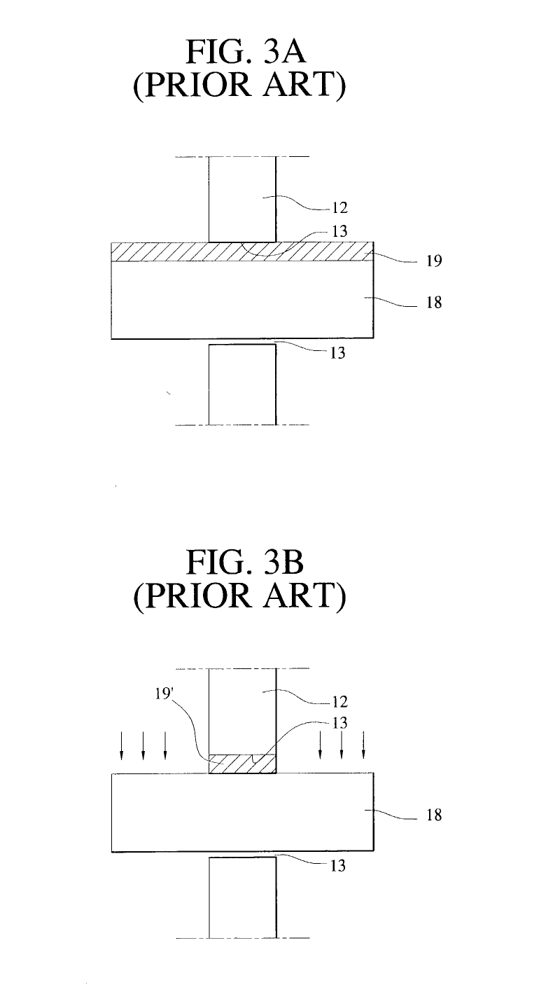

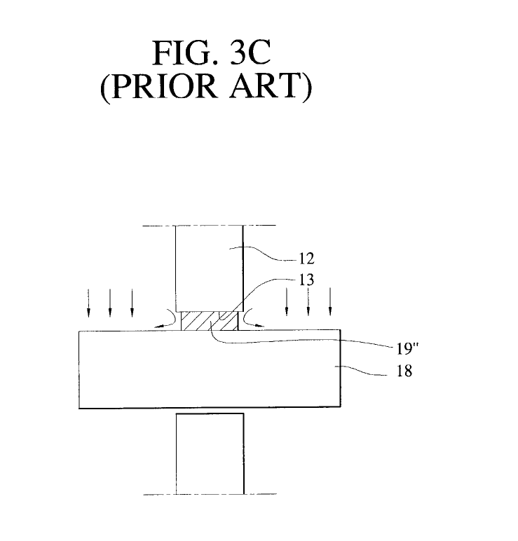

### DETAILED DESCRIPTION OF THE INVENTION

Korean Patent Application No. 2001-78657, filed on Dec. 12, 2001, and entitled: “Wafer Guide and Cleaning Apparatus Having the Same,” is incorporated by reference herein in its entirety.

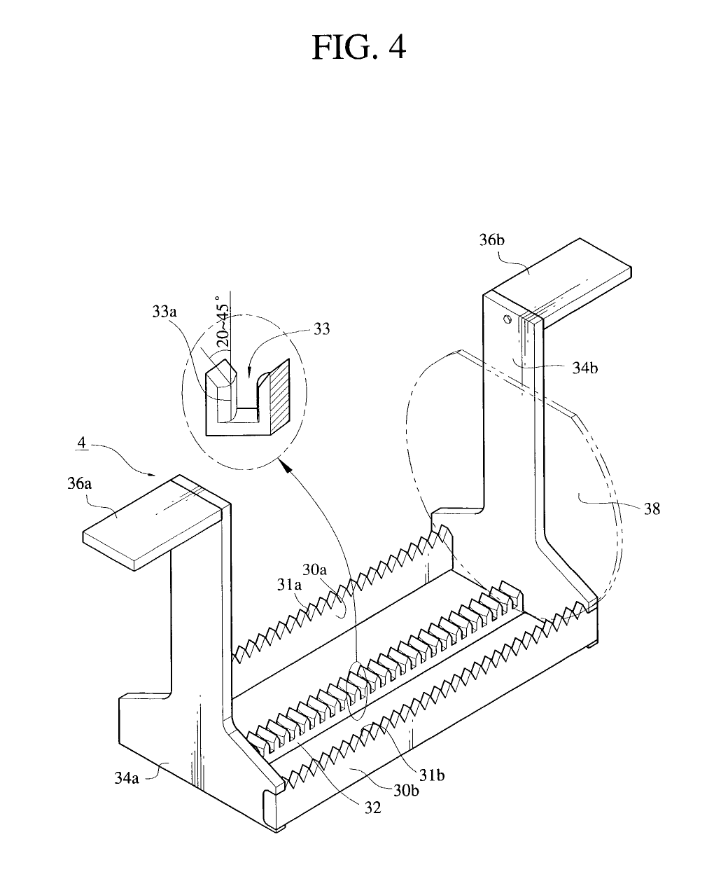

FIG. 4 illustrates a perspective view of a wafer guide in accordance with a first preferred embodiment of the present invention. The wafer guide 4 includes a pair of side panels 30a and 30b, a center panel 32 and a pair of fixing plates 34a and 34b. The side panels 30a and 30b and the center panel 32, which is located between the side panels 30a and 30b, are fixedly attached to the fixing plates 34a and 34b at both ends.

Each of the side panels 30a and 30b has a plurality of V-shaped side fixing grooves 31a and 31b on an upper surface thereof for stabilizing a wafer 38. In addition, the side panels 30a and 30b maintain a sufficient distance between a surface of the wafer 38 and an adjacent surface, such as another wafer, if present, or the fixing plates 34a and 34b. The center panel 32 has a plurality of Y-shaped center fixing grooves 33 on an upper surface thereof for supporting the wafer 38. The center fixing grooves 33 have inner walls formed with a rounded shape to establish a contact line 33a, as opposed to a contact plane. Accordingly, the center fixing grooves 33 of the wafer guide 4 only contact the wafer 38 at the contact line, so that a portion of the wafer 38 in contact with the wafer guide 4 is minimized.

The side panels 30a and 30b, and the side fixing grooves 31a and 31b thereof stabilize the wafers so the wafers are not separated from the wafer guide 4. The center panel 32 and the center fixing grooves 33 provide the primary support for the wafer 38. Further, an upper surface of the center fixing grooves 33 descends from both edges to the center thereof at an inclination of between about 20-45° so that the wafers may be smoothly slid into the center fixing grooves 33 along a sloped surface.

Each of the fixing plates 34a and 34b has a protrusion 36a and 36b outwardly extending from a top end thereof. In operation, the wafer guide 4 is removably attached to a bath of a cleaning apparatus by resting the protrusions 36a and 36b on a top of the bath. Preferably, the wafer guide 4 is made of quartz or Teflon®.

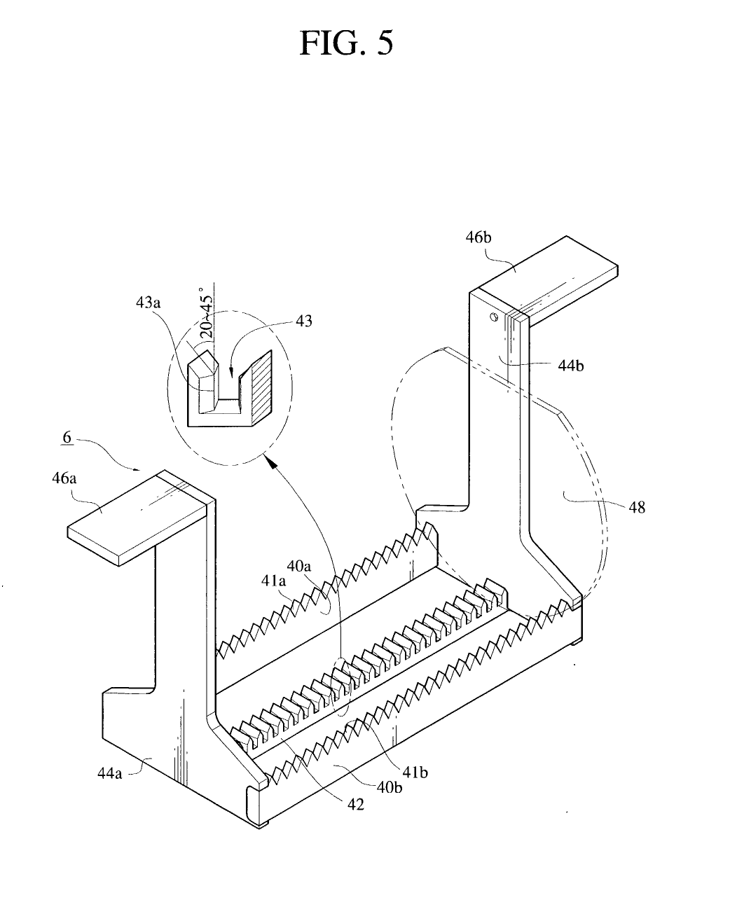

FIG. 5 illustrates a wafer guide 6 in accordance with a second preferred embodiment of the present invention. The wafer guide 6 includes a pair of side panels 40a and 40b, a center panel 42 and a pair of fixing plates 44a and 44b. The side panels 40a and 40b and the center panel 42, which is located between the side panels 40a and 40b, are attached to the fixing plates 44a and 44b at both ends.

Each of the side panels 40a and 40b has a plurality of V-shaped side fixing grooves 41a and 41b on an upper surface thereof for stabilizing a wafer 48. In addition, the side panels 40a and 40b maintain a sufficient distance between a surface of the wafer 48 and an adjacent surface, such as another wafer, if present, or the fixing plates 44a and 44b. The center panel 42 has a plurality of Y-shaped center fixing grooves 43 on an upper surface thereof for primarily supporting the wafer 48. The center fixing grooves 43 have inner walls formed in a triangular prism shape to establish a contact line 43a, as opposed to a contact plane. More specifically, each of the inner walls are angled from the center to both side edges. Accordingly, the center fixing grooves 43 of the wafer guide 6 only contact the wafer 48 at the contact line 43a, so that a portion of the wafer 48 in contact with the wafer guide 6 is minimized.

The side panels 40a and 40b, and the side fixing grooves 41a and 41b thereof stabilize the wafers so the wafers are not separated from the wafer guide 6. The center panel 42 and the center fixing grooves 43 provide the primary support for the wafer 48. Further, an upper surface of the center fixing grooves 43 descends from both edges to the center thereof at an inclination of between about 20-45° so that the wafers may be smoothly slid into the center fixing grooves 43 along a sloped surface.

The fixing plates 44a and 44b have a protrusion 46a or 46b outwardly extending from a top end thereof. In operation, the wafer guide 6 is removably attached to a bath of a cleaning apparatus by resting the protrusions 36a and 36b on a top of the bath, Preferably, the wafer guide 6 is made of quartz or Teflon®.

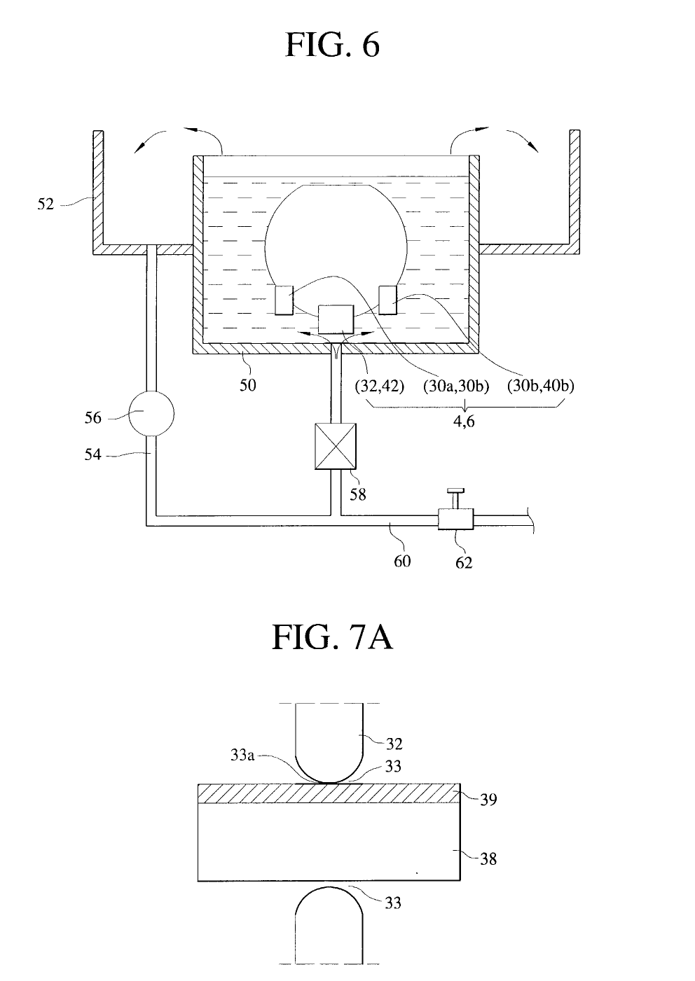

FIG. 6 illustrates a schematic view of a cleaning apparatus having a wafer guide in accordance with the present invention. As shown in FIG. 6, the wafer guide (4 or 6) having a plurality of wafers mounted therein is inserted into an interior bath 50 containing a cleaning solution. At this time, the protrusions (not shown in FIG. 6 but shown in FIG. 4 or 5, see 36a and 36b, 46a and 46b) are rested on both top ends of the interior bath 50.

An exterior bath 52 is installed outside the interior bath to surround an upper part of the interior bath 50 to receive and store the cleaning solution that may overflow from the interior bath 50. Bottoms of the exterior bath 52 and the interior bath 50 are connected to each other by a circulation pipe 54 interposed by a pump 56 and a filter 58. A drain pipe 60 is branched off from the circulation pipe 54 between the pump 56 and the filter 58.

After the cleaning solution stored in the interior bath 50 overflows to the exterior bath 52, the pump 56 operates to filter the overflowed cleaning solution through the filter 58 and then to return the overflowed cleaning solution to the interior bath 50. The cleaning solution is continuously filtered by a circulation operation. When the cleaning solution becomes sufficiently degraded in quality so as to be unusable, a valve 62 is opened and the used cleaning solution stored in the interior bath 50 and the exterior bath 52 are drained. Supply of new cleaning solution to the baths 50 and 52 follows.

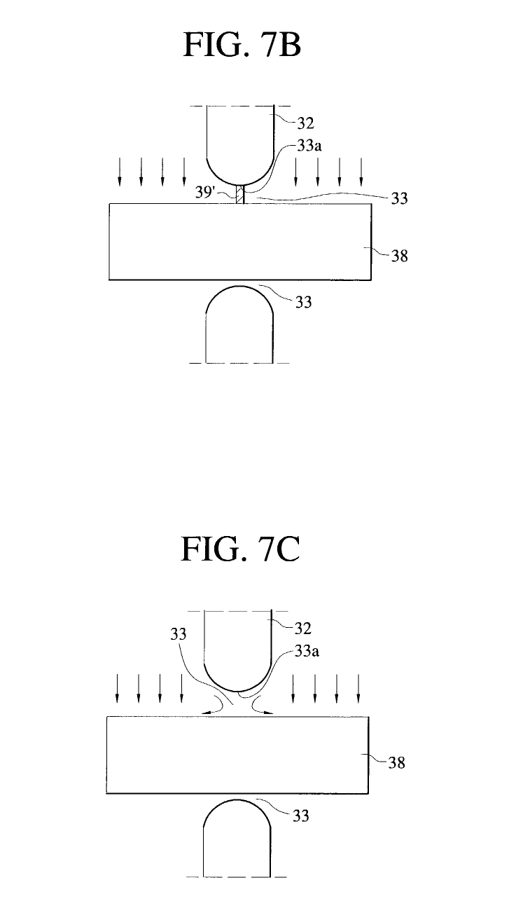

FIGS. 7A through 7C illustrate top views of the wafer guide in which the wafers 38 are mounted during a cleaning process in accordance with the first preferred embodiment of the present invention.

First, as shown in FIG. 7A, the wafer 38 having a thin film 39 on a surface thereof is received in the center fixing groove 33 of the center panel 32 of the wafer guide. At this time, only a small portion of the thin film 39 on the wafer 38 is in contact with the inner wall of the center fixing groove 33, in particular at the contact line 33a, because of the rounded shape of the inner walls of the center fixing grooves 33.

Next, as shown in FIG. 7B, most of the thin film 39 on the wafer 38 is removed by chemically reacting with the cleaning solution stored in interior bath 50. More specifically, the thin film 39 is removed from all areas except for at the contact line 33a. At the contact line 33a, a residue of thin film 39′ remains.

Finally, as shown in FIG. 7C, the remaining thin film (39′ in FIG. 7B) is completely removed by an isotropic etching characteristic of the cleaning solution, so that there no residue remains on the wafer 38. The cleaning solution is able to remove completely the residue of the thin film 39′ because the contact area is sufficiently small to allow the cleaning solution to etch to the center of the contact line 33a.

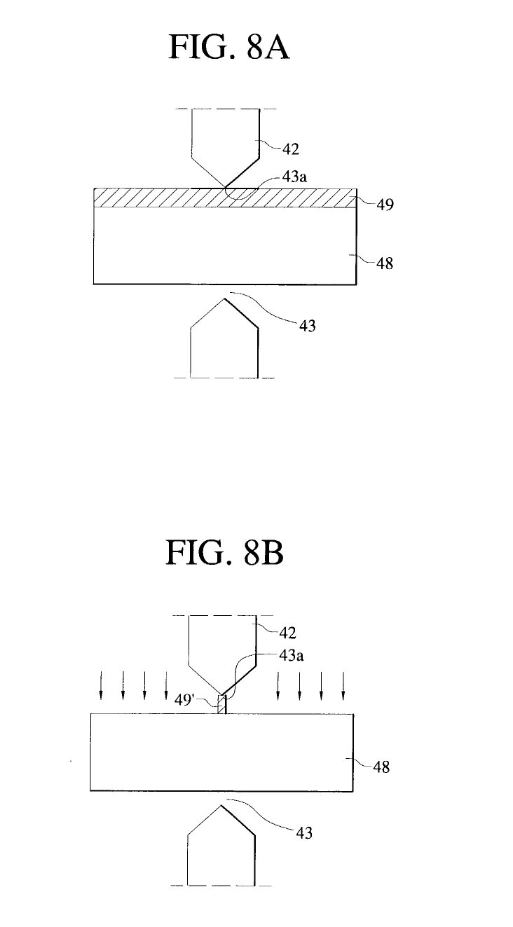

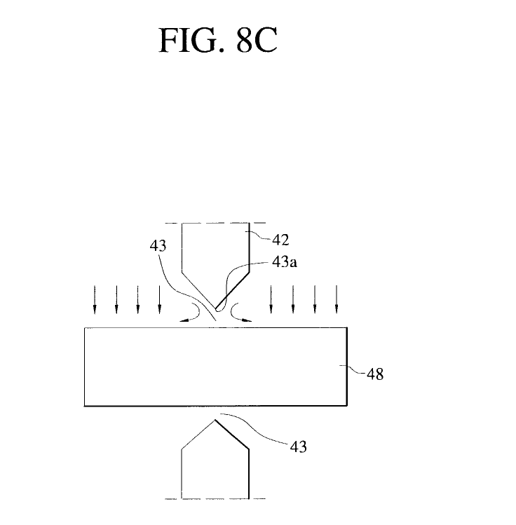

FIGS. 8A through 8C illustrate top views of the wafer guide in which the wafers 48 are mounted during a cleaning process in accordance with the second preferred embodiment of the present invention.

First, as shown in FIG. 8A, the wafer 48 having a thin film 49 on a surface thereof is received in the center fixing groove 43 of the center panel 42 of the wafer guide. At this time, only a small portion of the thin film 49 on the wafer 48 is in contact with the inner wall of the center fixing groove 43, in particular at the contact line 43a, because of the triangular prism shape of the inner walls of the center fixing grooves 43.

Next, as shown in FIG. 8B, most of the thin film 49 on the wafer 48 is removed by chemically reacting with the cleaning solution stored in interior bath 50. More specifically, the thin film 49 is removed from all areas except for at the contact line 43a. At the contact line 43a, a residue of thin film 49′ remains.

Finally, as shown in FIG. 8C, the remaining thin film (49′ in FIG. 8B) is completely removed by an isotropic etching characteristic of the cleaning solution, so that no residue remains on the wafer 48. The cleaning solution is able to remove completely the residue of the thin film 49′ because the contact area is sufficiently small to allow the cleaning solution to etch to the center of the contact line 43a.

As described above, the present invention provides a wafer guide and a cleaning apparatus having the same that is capable of preventing a residue from remaining on a surface of a wafer after a cleaning process by minimizing a contact area between the wafer guide and the wafer.

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A wafer guide for supporting at least one semiconductor wafer during a cleaning process, comprising:
a pair of side panels, each side panel having two ends, an upper surface and a plurality of side fixing grooves on the upper surface thereof for stabilizing the at least one semiconductor wafer and for maintaining a sufficient distance between a surface of the at least one semiconductor wafer and an adjacent surface;
a center panel having two ends, an upper surface, and a plurality of center fixing grooves on the upper surface thereof for supporting the at least one semiconductor wafer, each of the plurality of center fixing grooves having inner walls, wherein a contact line is formed on each of the inner walls of the center fixing grooves, and wherein the center panel is positioned between the pair of side panels; and
a pair of fixing plates, one of the pair of fixing plates being fixedly attached at each end of the center panel and the pair of side panels.

2. The wafer guide as claimed in claim 1, wherein the contact line of the inner walls of each of the plurality of center fixing grooves is formed by the inner walls having a rounded shape.

3. The wafer guide as claimed in claim 2, wherein an upper surface of each of the plurality of center fixing grooves is sloped down toward the center thereof.

4. The wafer guide as claimed in claim 3, wherein the upper surface of each of the plurality of center fixing grooves is sloped down at an inclination of between about 20-45°.

5. The wafer guide as claimed in claim 1, wherein the contact line of the inner walls of each of the plurality of center fixing grooves is formed by the inner walls having a triangular prism shape.

6. The wafer guide as claimed in claim 5, wherein an upper surface of each of the plurality of center fixing grooves is sloped down toward the center thereof at an inclination of between about 20-45°.

7. The wafer guide as claimed in claim 1, wherein each of the plurality of side fixing grooves are V-shaped.

8. The wafer guide as claimed in claim 1, wherein each of the fixing plates has a protrusion outwardly extending from a top end thereof.

9. The wafer guide as claimed in claim 1, wherein the wafer guide is made of quartz or Teflon®.

10. A wafer guide for supporting at least one semiconductor wafer during a cleaning process, comprising:
a plurality of panels, each panel having two ends, an upper surface, and a plurality of grooves on the upper surface thereof and being separated from each other, wherein each of the plurality of grooves has an inner wall and the plurality of grooves of at least one of the plurality of the panels forms a contact line on inner walls thereof to contact the at least one semiconductor wafer; and
a pair of fixing plates attached to each of the panels at both ends thereof.

11. The wafer guide as claimed in claim 10, wherein the contact line of the inner walls of each of the plurality of grooves is formed by the inner walls having a rounded shape.

12. The wafer guide as claimed in claim 11, wherein an upper surface of each of the plurality of grooves is sloped down toward the center thereof at an inclination of between about 20-45°.

13. The wafer guide as claimed in claim 10, wherein the contact line of the inner walls of each of the plurality of grooves is formed by the inner walls having a triangular prism shape.

14. The wafer guide as claimed in claim 10, wherein the inner walls of each of the plurality of grooves descend toward both side edges.

15. The wafer guide as claimed in claim 14, wherein an upper part of each of the plurality of grooves is sloped down toward the center thereof at an inclination of between about 20-45°.

16. A cleaning apparatus having a wafer guide for supporting at least one semiconductor wafer, the wafer guide comprising:
a pair of side panels, each side panel having two ends and a plurality of side fixing grooves at an upper surface for stabilizing the at least one semiconductor wafer, the pair of side panels being separated from each other;
a center panel having two ends and a plurality of center fixing grooves at an upper surface thereof for supporting the at least one semiconductor wafer, each of the plurality of center fixing grooves having inner walls, wherein a contact line is formed on each of the inner walls of the center fixing grooves by either rounding the inner walls or shaping the inner walls to descend toward the center from both side edges, and wherein the center panel is positioned between the pair of side panels; and
a pair of fixing plates, one of the pair of fixing plates being fixedly attached at each end of the center panel and the pair of side panels.
